(19) United States
(12) Patent Application Publication
(10) Pub. No.: US 2018/0239333 A1
(43) Pub. Date: Aug. 23, 2018

(54) CONTROL DEVICE FOR INDUSTRIAL MACHINE AND MANAGAGEMENT SYSTEM FOR INDUSTRIAL MACHINE

(71) Applicant: FANUC CORPORATION, Yamanashi (JP)

(72) Inventors: Tatsuhiro Uchiyama, Yamanashi-ken (JP); Junpei Maruyama, Yamanashi-ken (JP)

(73) Assignee: FANUC CORPORATION, Yamanashi (JP)

(21) Appl. No.: 15/898,798

(22) Filed: Feb. 19, 2018

(30) Foreign Application Priority Data
Feb. 22, 2017 (JP) 2017-030807

(51) Int. Cl. G05B 19/408; G05B 19/4155; G06K 19/06

(52) U.S. Cl. CPC G05B 19/408; G05B 2219/24019; G06K 19/06037; G05B 19/4155

(57) ABSTRACT

A control device for an injection molding machine includes a storage unit for storing information on the injection molding machine, an encoding unit for encoding the information stored in the storage unit to generate a code image, and a display unit for displaying the code image.

### CROSS-REFERENCE TO RELATED APPLICATION

This application is based upon and claims the benefit of priority from Japanese Patent Application No. 2017-030807 filed on Feb. 22, 2017, the contents of which are incorporated herein by reference.

### BACKGROUND OF THE INVENTION

### Field of the Invention:

The present invention relates to a control device for an industrial machine and a management system for an industrial machine.

### Description of the Related Art:

Japanese Laid-Open Patent Publication No. 2004-155055 discloses a configuration in which a host computer and process controllers provided for multiple injection molding machines are connected by cables for LAN communication so that an operation state and other information of each injection molding machine is transmitted from the process controller to the host computer.

### SUMMARY OF THE INVENTION

In the above-mentioned Japanese Laid-Open Patent Publication No. 2004-155055, the host computer and the process controller (control device) of each injection molding machine are connected by a communication network, but in many cases, the control devices of industrial machines such as injection molding machines have no means for connecting to a communication network. In such a case, the operator has to collect information on the industrial machine stored in the control device by handwriting or storing it in a medium, and input the collected information into a management device for managing the industrial machine, and such operations are complicated and tedious.

The present invention has been devised to solve the above problem, it is therefore an object of the present invention to provide a control device for an industrial machine and a management system for an industrial machine, which enable easy collection of information on the industrial machine stored in the control device of the industrial machine that is not connected to a communication network.

According to an aspect of the present invention, there is provided a control device for an industrial machine, which includes: a storage unit configured to store information on the industrial machine; an encoding unit configured to encode the information stored in the storage unit to generate a code image; and a display unit configured to display the code image.

According to the present invention, information on an industrial machine stored in a control device thereof can be collected easily even if the industrial machine is not connected to a communication network.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a configuration of a management system according to a first embodiment of the present invention;

FIG. 2 is a block diagram showing a configuration of a control device according to the first embodiment;

FIG. 3 is a diagram showing an example of a screen when a two-dimensional code image is displayed on a display unit of the first embodiment;

FIG. 4 is a block diagram showing a configuration of a mobile terminal and a management device according to the first embodiment;

FIG. 5 is a block diagram showing a configuration of a mobile terminal according to a second embodiment of the present invention; and

FIG. 6 is a block diagram showing a configuration of a mobile terminal and a management device according to a third embodiment of the present invention.

### DESCRIPTION OF THE PREFERRED EMBODIMENTS

Hereinafter, the present invention will be described referring to embodiments of the invention. The present invention specified in the scope of claims is not limited to the following embodiments. Not all combinations of features described in the embodiments are necessarily essential to the solving means of the invention.

### First Embodiment

### [Configuration of Management System]

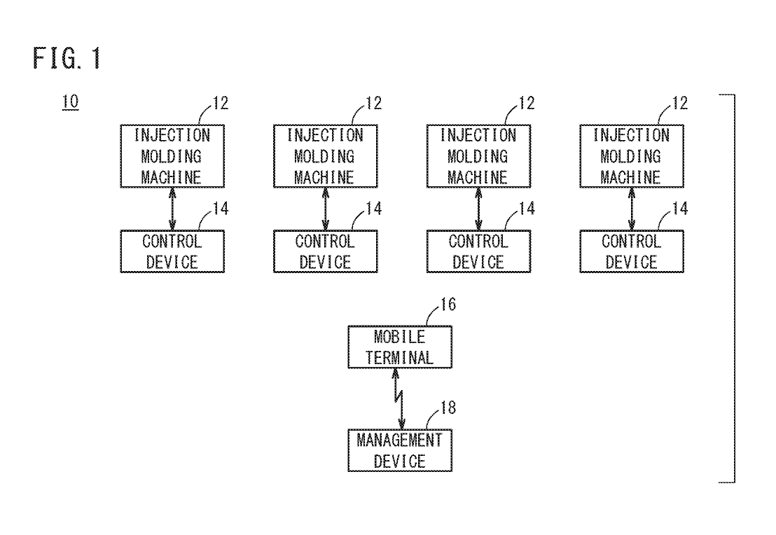

FIG. 1 is a schematic diagram showing a configuration of a management system 10 according to this embodiment. The management system 10 includes control devices 14, a mobile terminal 16 and a management device 18. The control device 14 calculates various signals for controlling an injection molding machine (industrial machine) 12 and outputs the calculated signals as command signals to the injection molding machine 12. Further, the control device 14 collects production information, maintenance information and the like relating to the injection molding machine 12. In the present embodiment, for example, multiple injection molding machines 12 are installed in a factory, each of which is equipped with one control device 14. Each control device 14 is not connected to a communication network but operates stand-alone. At least one mobile terminal 16 is provided for all the control devices 14 in the factory. At least one management device 18 is provided for all the control devices 14 in the factory. The mobile terminal 16 and the management device 18 are wirelessly connected to each other so as to enable communication.

In the management system 10 according to the present embodiment, information on each injection molding machine 12 collected by the corresponding control device 14 that operates stand-alone is collected using the mobile terminal 16, which in turn sends the collected information to the management device 18, and the information of the injection molding machines 12 in the factory is managed by the management device 18.

### [Configuration of Control Device]

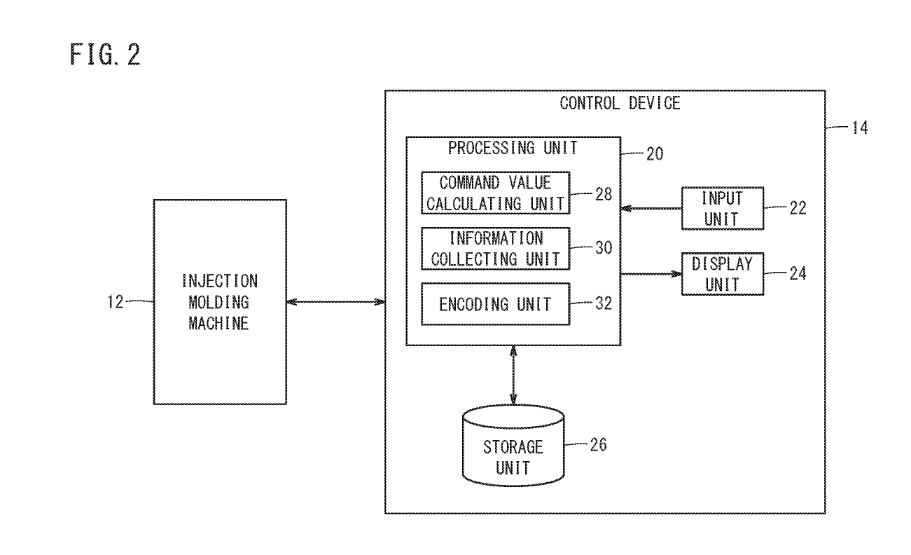

FIG. 2 is a block diagram showing a configuration of the control device 14. The control device 14 includes a processing unit 20, an input unit 22, a display unit 24, and a storage unit 26.

The processing unit 20 is a processor such as a CPU, and includes a command value calculating unit 28, an information collecting unit 30, and an encoding unit 32. The command value calculating unit 28 calculates various command values for driving the injection molding machine 12 and outputs the command values as command signals to the injection molding machine 12.

The information collecting unit 30 collects production information and maintenance information relating to the injection molding machine 12. The production information may include, for example, the product name (or product number) of the molded article to be formed by the injection molding machine 12, the name of the mold attached to the injection molding machine 12, the name of the resin material used in the injection molding machine 12, production start time, production end time, scheduled production quantity of the product, actual production quantity of the product, the number of cycles of the injection molding machine 12, the mold clamping force of the injection molding machine 12 and the like. The maintenance information may include the date and time at which the maintenance work of the injection molding machine 12 was performed, the various setting values (the setting value of mold clamping force, the setting value of maximum injection pressure, etc.) of the injection molding machine 12, information on specifications of the injection molding machine 12 such as the screw diameter, the serial number of the injection molding machine 12 and the like. The information collected by the information collecting unit 30 is stored into the storage unit 26. The encoding unit 32 encodes the information stored in the storage unit 26 to generate a two-dimensional code image.

The input unit 22 may include a mouse, a keyboard and a touch panel, and is operated by an operator to input various commands and the like to the control device 14. The display unit 24 is a liquid crystal display or the like, and displays text, images and others. In addition to information collected by the information collecting unit 30, the storage unit 26 stores programs and the like that enables the command value calculating unit 28 to calculate various command values.

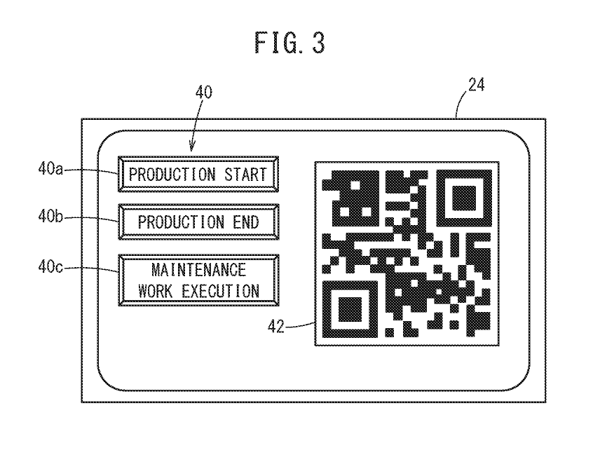

FIG. 3 is a diagram showing a screen example when a two-dimensional code image is displayed on the display unit 24. The display unit 24 can selectively display various screens in accordance with a switching operation performed by an operator operating the input unit 22. The screen shown in FIG. 3 is displayed when the operator performs a predetermined operation through the input unit 22. In the example shown in FIG. 3, the display unit 24 includes an operation button display area 40 and a two-dimensional code display area 42.

In the operation button display area 40 of the display unit 24, a production start button 40a, a production end button 40b and a maintenance work execution button 40c are displayed. The operator operates the input unit 22 to select one of the buttons 40a to 40c. Depending on the selected one of the buttons 40a to 40c, the encoding unit 32 retrieves information from the storage unit 26 and generates a two-dimensional code image of the selected information.

When the production start button 40a is selected through the input unit 22, the encoding unit 32 retrieves, as the information for generating a two-dimensional code image, the product name (or product number) of the molded article to be formed by the injection molding machine 12, the name of the mold attached to the injection molding machine 12, the name of the resin material to be used in the injection molding machine 12, the production start time and the scheduled production quantity of the product, and generates a two-dimensional code image of the selected information.

When the production end button 40b is selected through the input unit 22, the encoding unit 32 retrieves, as the information for generating a two-dimensional code image, the product name (or product number) of the molded article formed by the injection molding machine 12, the name of the mold attached to the injection molding machine 12, the name of the resin material used in the injection molding machine 12, the production end time and the actual production quantity of the product, and generates a two-dimensional code image of the selected information.

When the maintenance work execution button 40c is selected through the input unit 22, the encoding unit 32 retrieves, as the information for generating a two-dimensional code image, the date and time when the maintenance work of the injection molding machine 12 was performed, the number of cycles of the injection molding machine 12, various setting values (the setting value of mold clamping force, the setting value of maximum injection pressure, etc.) of the injection molding machine 12, information on the specifications of the injection molding machine 12 such as mold clamping force, screw diameter, etc. of the injection molding machine 12, and the production number of the injection molding machine 12, and generates a two-dimensional code image of the selected information.

The two-dimensional code image generated by the encoding unit 32 is displayed in the two-dimensional code display area 42 of the display unit 24.

### [Configuration of Mobile Terminal and Management Device]

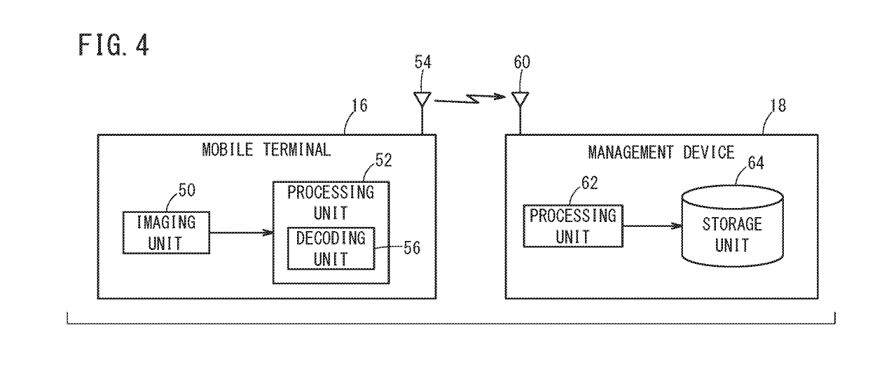

FIG. 4 is a block diagram showing a configuration of the mobile terminal 16 and the management device 18. The mobile terminal 16 includes an imaging unit 50, a processing unit 52 and a transmitting unit 54. The imaging unit 50 is a camera that captures the two-dimensional code image displayed on the display unit 24 of the control device 14. The processing unit 52 is a processor such as a CPU and performs processing of the image captured by the imaging unit 50 and control of the transmitting unit 54 and others. The processing unit 52 also includes a decoding unit 56. The decoding unit 56 decodes the two-dimensional code image captured by the imaging unit 50 to restore the information. The transmitting unit 54 wirelessly transmits the information restored by the decoding unit 56 to the management device 18.

The management device 18 includes a receiving unit 60, a processing unit 62 and a storage unit 64. The receiving unit 60 receives the information transmitted from the mobile terminal 16. The processing unit 62 is a processor such as a CPU, and sends the information received by the receiving unit 60 to the storage unit 64. The storage unit 64 stores the information. Note that the communication network between the mobile terminal 16 and the management device 18 may comprise only wireless connection, or may comprise combination of wireless and wired connections, or may comprise only of wired connection.

### [Operation and Effect]

In managing multiple injection molding machines 12, it is necessary for information on each of the injection molding machines 12 to be collected in the management device 18. However, many of the control devices 14 of the injection molding machine 12 operate stand-alone, and the operator has to collect the information on each injection molding machine 12 stored in the control device 14 thereof, by transcribing the information by handwriting or storing it in a medium to input the collected information into the management device 18, which would require complicated and tedious work of the operator.

In addition, in the case of the control device 14 operating stand-alone, the control device 14 contains no communication device in most cases. Therefore, when the control device 14 is connected to the same network as the management device 18, a communication device needs to be added to the control device 14, which causes a large cost.

To deal with this, in the present embodiment, the information on the injection molding machine 12 stored in the control device 14 is encoded to generate a two-dimensional code image, and the generated two-dimensional code image is displayed on the display unit 24. The two-dimensional code image displayed on the display unit 24 is photographed or captured by the mobile terminal 16, and the captured two-dimensional code image is decoded in the mobile terminal 16 so as to restore the information on the injection molding machine 12. The restored information on the injection molding machine 12 is collected by the management device 18 via the communication network. As a result, it is possible to easily collect the information on the injection molding machine 12 stored in the control device 14 that operates stand-alone.

### Second Embodiment

In a management system 10 of the second embodiment, no management device 18 is provided, and instead a mobile terminal 16 is used to manage an injection molding machine 12. Hereinafter, in the description of the second embodiment, the same components as those in the first embodiment will be allotted with the same reference numerals, and the description thereof will be omitted.

### [Configuration of Mobile Terminal]

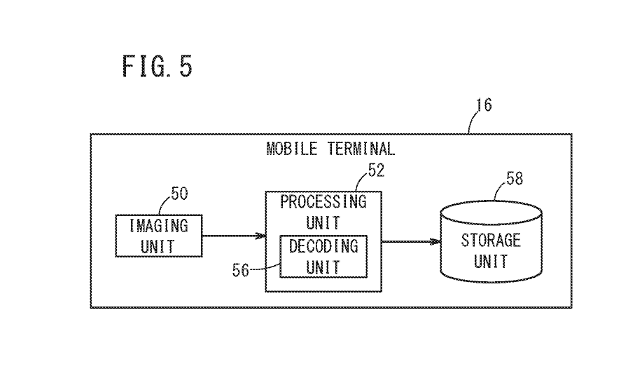

FIG. 5 is a block diagram showing a configuration of the mobile terminal 16. The mobile terminal 16 includes an imaging unit 50, a processing unit 52 and a storage unit 58.

The imaging unit 50 is a camera that captures the two-dimensional code image displayed on the display unit 24 of the control device 14. The processing unit 52 is a processor such as a CPU and performs processing of the image captured by the imaging unit 50. The processing unit 52 also includes a decoding unit 56. The decoding unit 56 decodes the two-dimensional code image captured by the imaging unit 50 and restores the information. The storage unit 58 stores the information restored by the decoding unit 56.

### [Operation and Effect]

In the second embodiment, the mobile terminal 16 stores the information on the injection molding machine 12 collected by the mobile terminal 16 into the storage unit 58 inside the mobile terminal 16. Providing the mobile terminal 16 with the management function of the injection molding machine 12 makes it possible to simplify the configuration of the management system 10.

### Third Embodiment

In the management system 10 according to the third embodiment, a decoding unit 56 is provided in a management device 18 although the decoding unit is provided in the mobile terminal 16 in the first embodiment. Hereinafter, in the description of the third embodiment, the same components as those in the first embodiment will be allotted with the same reference numerals, and the description thereof will be omitted.

### [Configuration of Mobile Terminal and Management Device]

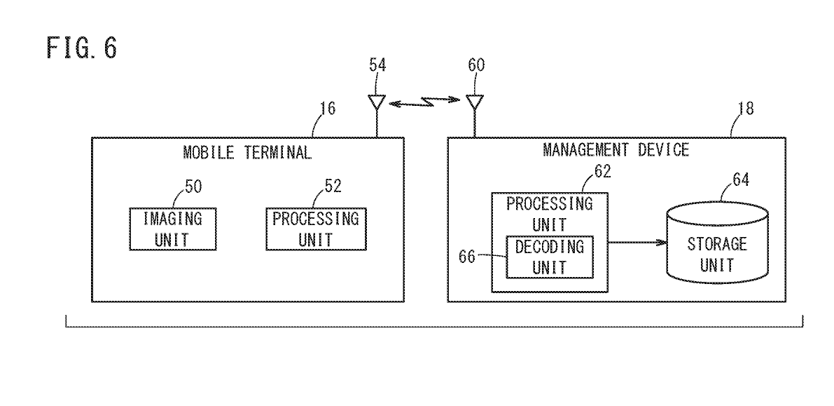

FIG. 6 is a block diagram showing a configuration of the mobile terminal 16 and the management device 18. The mobile terminal 16 includes an imaging unit 50, a processing unit 52 and a transmitting unit 54. The imaging unit 50 is a camera that captures a two-dimensional code image displayed on the display unit 24 of the control device 14. The processing unit 52 is a processor such as a CPU, and performs processing of the image captured by the imaging unit 50, control of the transmitting unit 54 and others. The transmitting unit 54 wirelessly transmits the two-dimensional code image captured by the imaging unit 50 to the management device 18.

The management device 18 includes a receiving unit 60, a processing unit 62 and a storage unit 64. The receiving unit 60 receives information transmitted from the mobile terminal 16. The processing unit 62 is a processor such as a CPU and performs control of the receiving unit 60 and others. The processing unit 62 also includes a decoding unit 66. The decoding unit 66 decodes the two-dimensional code image received by the receiving unit 60 and restores the information. The storage unit 64 stores the information restored by the decoding unit 66. Note that the communication network between the mobile terminal 16 and the management device 18 may comprise only wireless connection, may comprise combination of wireless and wired connections, or may comprise only wired connection.

### [Operation and Effect]

In the third embodiment, the mobile terminal 16 sends the captured two-dimensional code image to the management device 18, and the decoding unit 66 in the management device 18 decodes the two-dimensional code image. Therefore, it is possible to reduce the processing amount in the mobile terminal 16 with limited processing power of the processing unit 52 and limited battery capacity, and hence suppress the cost of the mobile terminal 16, so that the cost for the management system 10 can be suppressed as a whole.

### Other Embodiments

Although the present invention has been described based on the embodiments, the technical scope of the invention is not limited to the configurations described in the above embodiments. It goes without saying that various modifications and improvements can be added to the above embodiments. It is obvious from the description of the scope of the claims that modes with such modifications and improvements can also be included in the technical scope of the present invention.

Instead of the injection molding machine 12 of the above embodiments, the present invention can be applied to other industrial machines including machine tools such as machining centers, turning centers, electrical discharge machines and the like.

[Technical Idea Obtained from the Embodiments]

Technical ideas that can be grasped from the above embodiments will be described below.

A control device (14) for an industrial machine (12) includes: a storage unit (26) configured to store information on the industrial machine (12); an encoding unit (32) configured to encode the information stored in the storage unit (26) to generate a code image; and a display unit (24) configured to display the code image. With this configuration, the operator can collect information on the industrial machine (12) by capturing the code image displayed on the display unit (24).

In the above-described control device (14) for the industrial machine (12), the information may be production information or maintenance information of the industrial machine (12). Thereby, production information or maintenance information necessary for management of the industrial machine (12) can be easily collected.

The above-described control device (14) for the industrial machine (12) may further include an input unit (22), wherein an operator operates the input unit to thereby select piece of the information to be encoded, and the encoding unit (32) may encode the piece of the information selected through the input unit (22). With this configuration, it is possible to easily collect only the information the operator needs for management.

A management system (10) for an industrial machine (12) includes: the above-described control device (14) for the industrial machine (12); and a mobile terminal (16) including an imaging unit (50) configured to capture the code image displayed on the display unit (24). This configuration enables easy collection of the information on the industrial machine (12) stored in the control device (14) of the industrial machine (12) through the mobile terminal (16) even if the industrial machine operates stand-alone.

In the above-described management system (10) for the industrial machine (12), the mobile terminal (16) may include a decoding unit (56) configured to decode the captured code image to restore the information. This configuration enables easy collection of the information on the industrial machine (12) stored in the control device (14) thereof through the mobile terminal (16) even if the industrial machine operates stand-alone.

In the above-described management system (10) for the industrial machine (12), the mobile terminal (16) includes a storage unit (58) configured to store the restored information. As a result, the mobile terminal (16) can have the management function of the industrial machine (12), thereby making it possible to simplify the configuration of the management system (10).

The above-described management system (10) for the industrial machine (12) may further include a management device (18) connected to the mobile terminal (16) via a communication network, and the management device (18) may include a storage unit (64) configured to store the information sent from the mobile terminal (16) via the communication network. As a result, the information on the industrial machines (12) collected using the mobile terminal (16) can be sent from the mobile terminal (16) to the management device (18) via the communication network and stored in the storage unit (64) of the management device (18).

The above-described management system (10) for the industrial machine (12) may further include a management device (18) connected to the mobile terminal (16) via a communication network, and the management device (18) may include: a decoding unit (66) configured to decode the code image sent from the mobile terminal (16) via the communication network so as to restore the information; and a storage unit (64) configured to store the restored information. This makes it possible to reduce the processing amount in the mobile terminal (16) with limited processing power of the processing unit (52) and limited battery capacity, and hence suppress the cost of the mobile terminal (16), so that the cost for the management system (10) can be suppressed as a whole.

What is claimed is:

1. A control device for an industrial machine, comprising:
a storage unit configured to store information on the industrial machine;
an encoding unit configured to encode the information stored in the storage unit to generate a code image; and
a display unit configured to display the code image.

2. The control device for the industrial machine according to claim 1, wherein the information is production information or maintenance information of the industrial machine.

3. The control device for the industrial machine according to claim 2, further comprising an input unit, wherein an operator operates the input unit to thereby select piece of the information to be encoded, and the encoding unit encodes the piece of the information selected through the input unit.

4. A management system for an industrial machine, comprising:
a control device for an industrial machine, wherein the control device comprises: a storage unit configured to store information on the industrial machine; an encoding unit configured to encode the information stored in the storage unit to generate a code image; and a display unit configured to display the code image; and
a mobile terminal including an imaging unit configured to capture the code image displayed on the display unit.

5. The management system for the industrial machine according to claim 4, wherein the mobile terminal includes a decoding unit configured to decode the captured code image to restore the information.

6. The management system for the industrial machine according to claim 5, wherein the mobile terminal includes a storage unit configured to store the restored information.

7. The management system for the industrial machine according to claim 5, further comprising a management device connected to the mobile terminal via a communication network, wherein the management device includes a storage unit configured to store the information sent from the mobile terminal via the communication network.

8. The management system for the industrial machine according to claim 4, further comprising a management device connected to the mobile terminal via a communication network, wherein the management device includes: a decoding unit configured to decode the code image sent from the mobile terminal via the communication network so as to restore the information; and a storage unit configured to store the restored information.
